(19) United States
(12) Patent Application Publication
(10) Pub. No.: US 2007/0248385 A1
(43) Pub. Date: Oct. 25, 2007

(54) Material supply device

(76) Inventors: Patrick Dougherty, Boise, ID (US); Thomas Wayne Ives, Boise, ID (US); William Becia, Boise, ID (US); Thomas Krawzak, Boise, ID (US); Lyndon D. Nolan, Boise, ID (US); Kevin L. Falk, Boise, ID (US); Anita Tjan, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/410,740

(22) Filed: Apr. 24, 2006

(51) Int. Cl. G03G 15/09

(52) U.S. Cl. 399/272

(57) ABSTRACT

In one embodiment, a material supply device includes: a reservoir defined at least in part by a exterior wall, the wall having an elongated opening therein; an elongated surface close to and extending along the opening in the exterior wall of the reservoir, the surface movable relative to the wall; and a means for moving material directly from the reservoir to the surface through the slot.

### BACKGROUND

Stirring devices are often used in the toner reservoir in laser printers to keep toner readily available to the developer roller. Stirring contributes to toner wear, which can degrade print quality and limit the life of a print cartridge.

Laser printers typically are designed to function in a horizontal orientation—the axes of the photoconductor and developer roller are horizontal. Horizontal laser printers can take up more space on a work surface than a vertically oriented laser printer. That is to say, a vertical laser printer may have a smaller “footprint” than a horizontal laser printer. Horizontal laser printers, however, cannot simply be tipped up on end to function as a vertical laser printer because the toner delivery system cannot evenly supply toner to the developer roller as the toner supply is depleted.

### DRAWINGS

FIG. 1 is an elevation view of a vertically oriented material supply device according to one embodiment of the invention.

FIG. 2 is a section view taken along the line 2-2 in FIG. 1.

FIG. 3 is an elevation view of a vertically oriented toner supply device according to one embodiment of the invention.

FIG. 4 is a section view taken along the line 4-4 in FIG. 3.

FIG. 5 is a perspective view of a vertically oriented laser printer in which embodiments of the invention may be implemented.

FIG. 6 is a plan view diagram illustrating a vertically oriented laser printer, such as the one shown in FIG. 5, according to one embodiment of the invention.

FIGS. 7 and 8 illustrate print cartridges that may be used in a vertically oriented laser printer, according to embodiments of the invention.

### DETAILED DESCRIPTION

Embodiments of the invention were developed in an effort to provide a toner supply for laser printers that does not require stirring and that functions in a vertical orientation even as the toner supply is depleted. Some embodiments, therefore, are described with reference to a toner supply device and a laser printer. Embodiments of the invention, however, are not limited to toner supply or to use in laser printers.

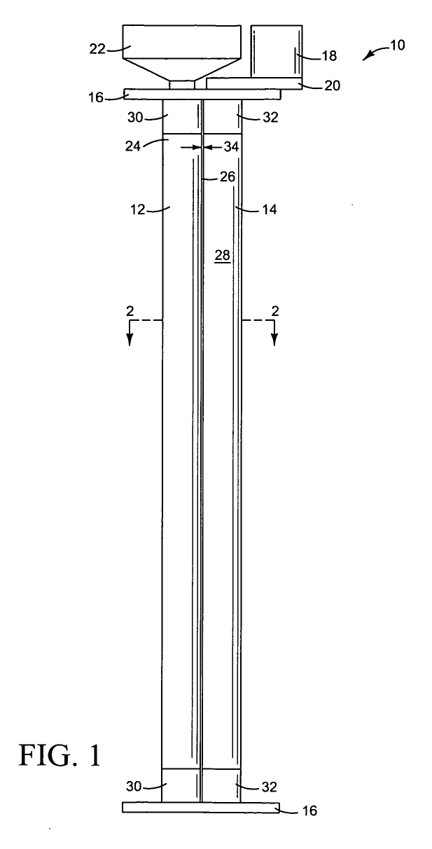

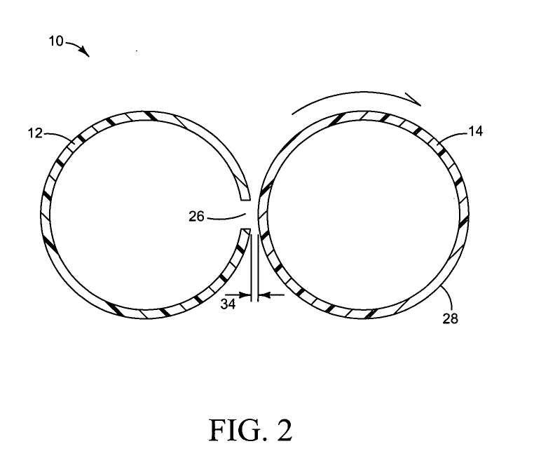

FIG. 1 is an elevation view of a vertically oriented material supply device 10 that includes a supply tube 12 for containing a material and a roller 14. FIG. 2 is a section view taken along the line 2-2 in FIG. 1. Referring to FIGS. 1 and 2, tube 12 and roller 14 are oriented vertically or nearly vertical and positioned parallel to one another. Tube 12 and roller 14 are supported on each end by a frame 16. Tube 12 is stationary, at least with respect to roller 14. Roller 14 rotates at the urging of a motor 18 through a gear train 20. Material is introduced into tube 12 through a hopper 22 connected to a top end 24 of tube 12. Tube 12 or tube 12 in combination with hopper 22 form a reservoir for material to be transferred to roller 14. A slot 26, shown in FIG. 2, extends lengthwise along tube 12. Roller 14 is positioned close to tube 12 so that, as roller 14 rotates and its outer surface 28 moves past slot 26, material may be transferred from tube 12 through slot 26 onto that portion of roller surface 28 facing slot 26. In the embodiment shown in FIG. 1, slot 26 extends between collars 30 that support tube 12 on frame 16 allowing the transfer of material along a corresponding length of roller 14 between support collars 32.

Slot 26 and the gap 34 between tube 12 and roller 14 are configured to allow the desired transfer of material from tube 12 onto roller surface 28 as roller 14 rotates and surface 28 moves past slot 26. For thinner materials that flow more easily, it is expected that a narrower slot 26 and a smaller gap 34 will be used to allow the desired transfer of material onto a faster moving roller surface 28. For thicker materials that flow less easily, it is expected that a wider slot 26 and a larger gap 34 will be used to allow the desired transfer of material onto a slower moving roller surface 28.

As used in this document: “tube” means a hollow elongated cylinder; “roller” means a rotatable cylinder; “cylinder” means the surface traced by a straight line moving parallel to a fixed straight line and intersecting a fixed planar closed curve; “slot” means a narrow opening or groove; “facing” means oriented toward; “close” means having sufficiently little space between items to allow the transfer of material from one item to the other item through a slot or other opening; and “nearly vertical” means within 5° of vertical. In the embodiment shown in FIGS. 1 and 2, tube 12 and roller 14 have a circular cross section. Other cross sections are possible.

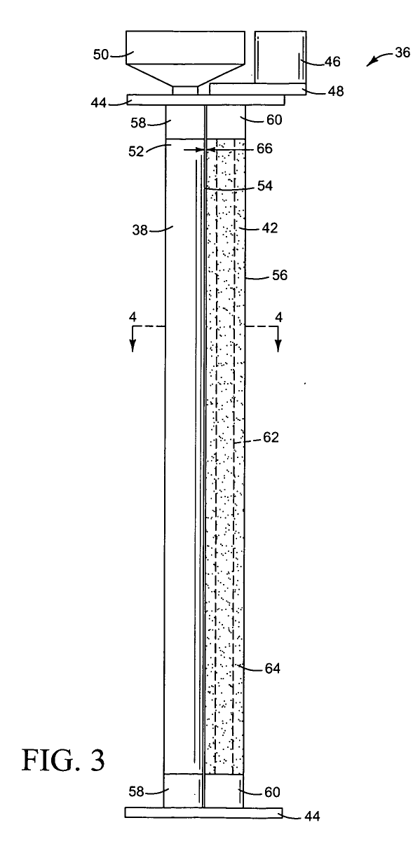

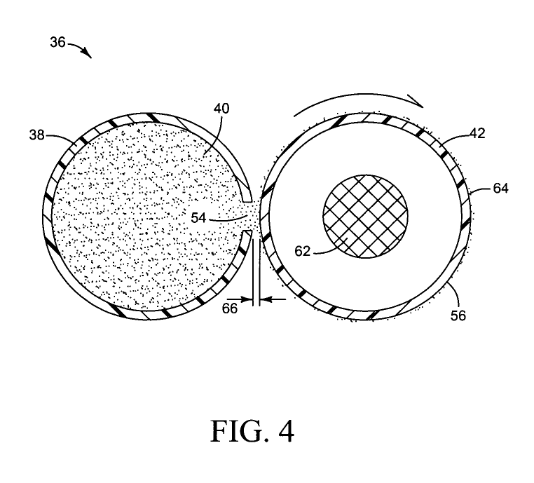

FIG. 3 is an elevation view of a vertically oriented toner supply device 36 such as might be used in a vertically oriented laser printer. FIG. 4 is a section view taken along the line 4-4 in FIG. 3. Referring to FIGS. 3-4, device 36 includes a toner supply tube 38 containing toner 40 and a developer roller 42. Tube 38 and roller 42 are oriented vertically and positioned parallel to one another. Tube 38 and roller 42 are supported on each end by a frame 44. Tube 38 is stationary. Roller 42 rotates at the urging of a motor 46 through a gear train 48. Toner is introduced into tube 38 through a hopper 50 connected to a top end 52 of tube 38. A slot 54, shown in FIG. 4, extends lengthwise along tube 38. Roller 42 is positioned close to tube 38 so that, as roller 42 rotates and its outer surface 56 moves past slot 54, toner 40 may be transferred from tube 38 through slot 54 onto that portion of roller surface 56 facing slot 54. Slot 54 extends between collars 58 that support tube 38 on frame 44 allowing the transfer of toner along a corresponding length of roller 42 between support collars 60.

The toner particles in conductive toners commonly used in many monochrome laser printers contain some form of iron. A magnet 62 mounted inside developer roller 42 attracts such toner particles at slot 54 to roller surface 56. Other means for moving the toner from the supply tube to the developer roller may be used. For example, the conductive toner particles commonly used in color laser printers do not contain any magnetic material. Such non-magnetic toner particles may be charged in supply tube 38. A corresponding charge applied to developer roller 42 can then be used to attract the charged toner particles onto roller surface 56. Gravity could also be used to move (or help move) toner from the supply tube to the developer roller. In a horizontally oriented toner supply device, for example, gravity might be the only means needed for moving toner from the supply tube to the developer roller.

As developer roller 42 rotates and roller surface 56 moves past slot 54, a thin film 64 of toner is formed on roller surface 56. Slot 54 and the gap 66 between tube 38 and roller 42 are configured to allow the desired transfer of toner 40 onto roller surface 56. For a typical dry toner in which the toner particles have a nominal diameter of 6-8 microns, a slot 54 1,000-2,500 microns wide and a gap 66 of 20-50 microns between tube 38 and roller surface 56 will allow the formation of a toner film 64 of about 50-100 microns on a typical developer roller 42. This is just one example of a configuration that may be implemented in a laser printer. Other configurations are possible. For example, the configuration of slot 54 and gap 66 may be adjusted for the use of different size toner particles in dry toners, or possibly even for the use of liquid toners, as well to accommodate different sizes, shapes and/or performance characteristics of developer roller 42.

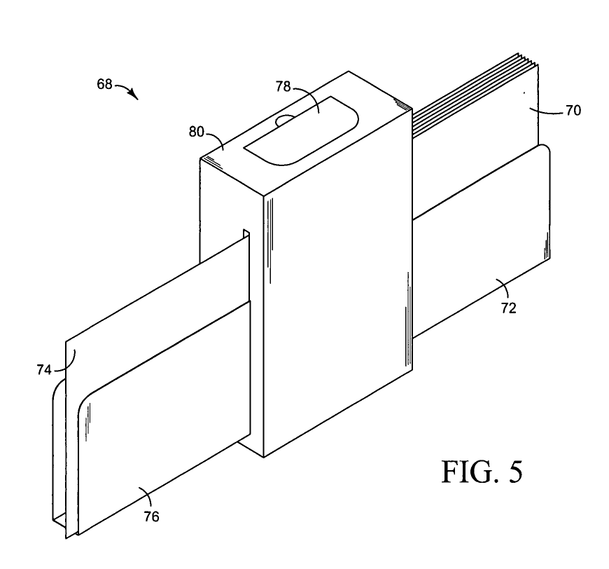

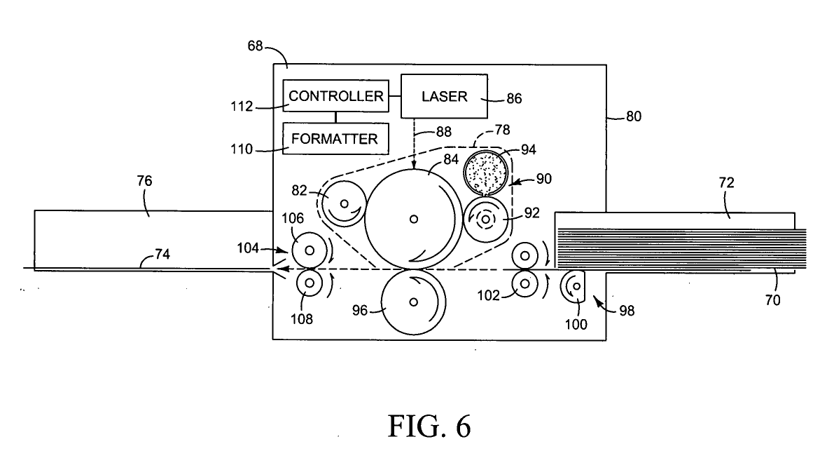

FIGS. 5 and 6 show a vertically oriented laser printer 68. Printer 68 illustrates one exemplary implementation for a toner supply device such as device 36 described above with reference to FIGS. 3 and 4. Referring first to FIG. 5, sheets 70 of paper or other print media are fed into printer 68 from an input tray 72 and printed sheets 74 are discharged to an output tray 76. A replaceable print cartridge 78 and other printer components are enclosed in a housing 80.

Referring now also to FIG. 6, printer 68 includes a charging roller 82 for charging the surface of a photoconductive drum 84 to a relatively high and substantially uniform level. The surface of photoconductive drum 84 includes photosensitive material that can be charged and discharged. A laser scanner 86 emits a beam of light 88 onto the uniformly charged surface of photoconductive drum 84 to discharge select areas of the surface of drum 84 corresponding to the image to be printed. The light beam is reflected off a multifaceted spinning mirror (not shown) to scan the beam across the surface of photoconductive drum 84. Photoconductive drum 84 rotates so that each successive scan of light beam 88 falls on drum 84 immediately after the previous scan.

Printer 68 includes a toner supply device 90 such as device 36 described above with reference to FIGS. 3 and 4. A film of toner is formed on the surface of a developer roller 92 as roller 92 rotates past a slotted toner supply tube 94. The surface of drum 84 exposed to light beam 88 rotates into contact with developer roller 92. Toner on the surface of developer roller 92 is attracted to and sticks on the discharged areas of the surface of drum 84. Toner is thereby transferred from developer roller 92 to drum 84 in the pattern of the latent image formed by the discharged areas on the surface of drum 84. As drum 84 continues to rotate, the toner on drum 84 is transferred to print media 70 at the nip between drum 84 and a transfer roller 96 to form the desired image on media 70. Transfer roller 96 may be charged to help draw the toner off drum 84 onto media 70. The surface of drum 84 may be cleaned of excess toner and then completely discharged before a uniform charged is restored by charging roller 82 in preparation for the next toner transfer.

As shown in FIG. 6, replaceable print cartridge 78 includes charging roller 82, photoconductive drum 84 and toner supply device 90. While this arrangement for the replaceable print cartridge is typical of many laser printers, other arrangements are possible. For example, in some, usually less expensive, laser printers, the replaceable print cartridge may include only the toner supply device or only the toner supply device and the photoconductive drum.

Each sheet of print media 70 is advanced to the photoconductive drum 84 by a sheet feed mechanism 98. Feed mechanism 98 includes a motor driven feed roller 100 and a pair of registration rollers 102. As feed roller 100 rotates, the surface of feed roller 100 contacts a sheet 70 and pulls it into printer 68 until the leading edge of sheet 70 moves into the nip between registration rollers 102. Registration rollers 102 advance sheet 70 fully into the imaging area where it is engaged between drum 84 and transfer roller 96 and toner is applied as described above. Sheet 70 now with toner applied is advanced along the media path through printer 68 to a fuser 104. Fuser 104 includes a fusing roller 106 and a pressure roller 108. One or both rollers 106 and 108 are heated so that as media sheet 70 passes between rollers 106 and 108 toner is fused to the media through the application of heat and pressure. Each sheet is then discharged to output tray 76 as a printed sheet 74.

Referring still to FIG. 6, print data from a host computer or other data source received by printer 68 is processed by a formatter 110 and controller 112. Formatter 110 typically formulates and stores an electronic representation of each page to be printed and breaks the page down into a series of lines one pixel high. The data for each line is sent to controller 112 which drives laser scanner 86 and controls the other operative components of printer 68. Each line of data is used to modulate light beam 88 emitted by laser scanner 86. While formatter 110 and controller 112 are depicted as discrete components in FIG. 6, each containing its own processor and associated programmable memory, the formatter and controller functions are often integrated into a single electronic component.

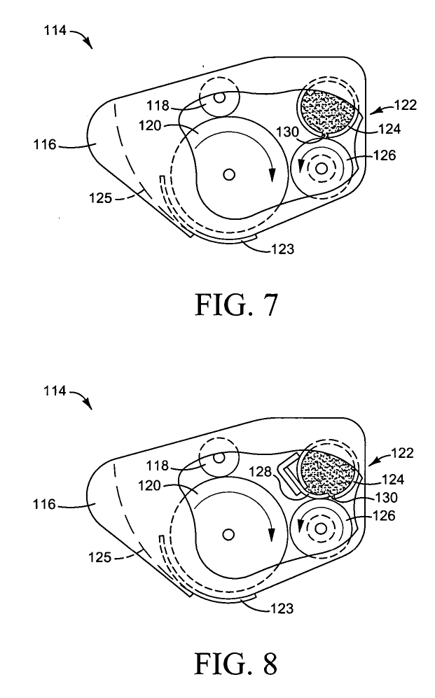

FIGS. 7 and 8 each illustrate one example of a replaceable print cartridge 114 that may be used in a vertically oriented laser printer, such as printer 68 illustrated in FIGS. 5-6. Referring to FIGS. 7 and 8, print cartridge 114 includes a housing 116 enclosing a charging roller 118, a photoconductive drum 120 and a toner supply device 122. Housing 116 is partially cut-away along the wavy line in each figure to better illustrate internal components 118, 120 and 122. A hinged cover 123 protects photoconductive drum 129 when cartridge 114 is not installed in a printer. When cartridge 114, cover 123 swings up, as indicated by the dashed lines 125, to expose photoconductive drum 120 for printing operations. Toner supply device 122 includes a slotted supply tube 124 and a developer roller 126. In the embodiment shown in FIG. 7, toner supply device 122 is configured like device 36 described above with reference to FIGS. 3 and 4. In the embodiment shown in FIG. 8, toner supply device 122 also includes a flexible blade 128 that spans part of an expanded slot 130 in supply tube 124. Blade 128, which is often referred to as a doctor blade, meters the amount of toner applied to the surface of developer roller 126 to help ensure a uniform toner film on roller 126. The extent to which doctor blade 128 spans slot 130 defines the width of the opening through which toner moves from supply tube 124 to roller 126.

The present invention has been shown and described with reference to the foregoing exemplary embodiments. It is to be understood, however, that other forms, details and embodiments may be made without departing from the spirit and scope of the invention which is defined in the following claims.

What is claimed is:

1. A material supply device, comprising:
a reservoir defined at least in part by an exterior wall having an elongated opening therein;
an elongated surface close to and extending along the opening in the exterior wall of the reservoir, the surface movable relative to the wall; and
a means for moving material directly from the reservoir to the surface through the opening.

2. The device of claim 1, further comprising a magnet near the surface opposite the opening and wherein the means for moving material comprises the magnet configured to attract magnetic material from the reservoir to the surface through the opening.

3. The device of claim 1, wherein the wall and the surface are oriented vertically or nearly vertical and positioned parallel to one another.

4. The device of claim 1, wherein the wall is convex.

5. The device of claim 1, wherein the surface is convex.

6. The device of claim 1, wherein the elongated opening comprises a single continuous elongated opening.

7. A toner supply device for a printer, comprising:
a tube for containing toner, the tube oriented vertically or nearly vertical and the tube having a single continuous slot therein along a length of the tube;
a roller for transferring toner to a photoconductive element;
a magnet inside the roller; and
the roller oriented parallel to the tube and positioned close to the tube along the slot such that toner in the slot is attracted on to an outer surface of the roller at the urging of the magnet.

8. The device of claim 7, wherein the slot is 1,000-2,500 microns wide and a gap between the slot and the outer surface of the roller is 20-50 microns.

9. The device of claim 7, further comprising toner in the tube.

10. The device of claim 7, further comprising a flexible blade extending substantially the full length of the slot, spanning part of the width of the slot and bearing against the outer surface of the roller.

11. The device of claim 7, further comprising a housing, the tube supported by the housing.

12. The device of claim 11, further comprising a photoconductive element supported by the housing near the roller.

13. The device of claim 12, further comprising a charging device supported by the housing near the photoconductive element.

14. A marking material supply device for a printer, comprising:
a stationary container for a marking material defined at least in part by an exterior wall having a slot therein;
a roller having an outside surface; and
a means for moving marking material directly from the container to the outside surface of the roller through the slot; and
the roller positioned close to the exterior wall of the container along the slot such that marking material in the slot is moved on to an outer surface of the roller at the urging of the moving means.

15. The device of claim 14, wherein the slot comprises a single continuous slot.

16. The device of claim 15, wherein the exterior wall of the container and the outer surface of the roller are oriented vertically or nearly vertical and positioned parallel to one another.

17. The device of claim 16, further comprising a magnet inside the roller and wherein the moving means comprises the magnet configured to attract magnetic marking material from the container to the outer surface of the roller through the slot.

18. The device of claim 17, wherein the magnetic marking material comprises toner.
